(19) United States
(12) Patent Application Publication
(10) Pub. No.: US 2005/0114447 A1
(43) Pub. Date: May 26, 2005

(54) Method and system for identity exchange and recognition for groups and group members

(76) Inventors: Kim Cameron, Bellevue, WA (US); Don Hacherl, North Bend, WA (US)

Correspondence Address: Homer Knearl;Merchant & Gould P.C., P.O. Box 2903, Minneapolis, MN, 55402-0903, US

(21) Appl. No.: 10/692,530

(22) Filed: Oct. 24, 2003

(51) Int. Cl. G06F 15/16

(52) U.S. Cl. 709/204

(57) ABSTRACT

A group certificate is used in a communication system to establish and recognize a group identity at a receiving system. Once a group identity is recognized, members of the group may be recognized based on membership certificates, or they may be recognized based on their own personal certificates separate from the group. In other words a member may be recognized based on trust by the recipient in the group or based on trust by the recipient in the member personally. Group identity information is created for inclusion in the group certificate. A group-signed group certificate is generated, and the certificate has as the group identity information, at least a first key, and a digital signature signed using a second key associated with the first key in the group certificate. The group-signed group certificate is sent to a receiving system to establish the group identity at the receiving system. A group-signed group membership certificate is sent to the receiving system to establish membership of the originator of the membership certificate in the group whose group identity is established at the receiving system. A security protocol is assigned to communications from group members based on the group identity information if the membership certificate is accepted. A security protocol is also assigned to communications from a group member based on a personal identity if a personal certificate is accepted.

### CROSS REFERENCE TO RELATED APPLICATION

The present application is related to U.S. patent application Ser. No. ______, entitled METHOD AND SYSTEM FOR IDENTITY EXCHANGE AND RECOGNITION (Attorney Docket No. 40062.0215US01), filed concurrently herewith and assigned to the Assignee of the present invention.

### TECHNICAL FIELD

The invention relates generally to the field of computer and network security. More particularly, the invention relates to exchanging group-controlled identity information and group member-controlled identity information between disparate computer systems.

### BACKGROUND OF THE INVENTION

It is often desired to share a computer's resources with users across a network that do not have any representation on the computer from which resources are to be shared. For example, a corporation, university, or other organization may have one or more servers connected to some type of network for use by employees, students, or other individuals. Various entities, including individuals, share information or resources across the Internet or other networks. Wired and wireless networks are becoming more popular for use in homes and a wide range of devices, from personal computers to household appliances are or will be connected to and accessible through these networks. As easier access to a wider variety of resources becomes available, the secure sharing of and collaboration between these resources becomes more important.

One obstacle to the secure sharing of and collaboration between these resources relates to recognizing and authenticating various entities that attempt to access the resources provided. In other words, care must be taken to ascertain and ensure that an entity attempting to access a resource on a computer is the entity it claims to be and has the authorization needed to access those resources. Various methods of recognizing an entity and granting authorization have been used.

One method of recognizing and granting authorization to an entity involves a system of accounts and passwords set up to define a security domain. For example, a corporation may wish to generate a security domain for a server or network where the security domain consists of every full-time employee of the corporation. Those running the security domain, such as system administrators, give each employee an account, typically including a user name and password, and set up policies controlling access to the resources through these accounts. Once a security domain is in place, domain members can be given access to the resources while those without accounts are excluded.

However, a security domain based on a system of accounts requiring users to remember various user names and passwords can be cumbersome. Further, a security domain based on a system of accounts is not a good model for individuals wishing to share information or resources across a network such as the Internet. Additionally, for various business reasons, there may be a need to extend or even replace the traditional closed security domain with individuals chosen from across the Internet. For example, there may be a need to set up a project where employees, outside contractors, and other individuals or entities can be part of a virtual team, accessing shared documents, communications, and other resources.

While it is relatively easy to assume that anyone using an account with a valid username and password for accessing resources is the owner of that account, it has been very difficult to recognize identities which are not a part of a traditional closed security domain. Public key infrastructures have been used as a way to identify and authenticate entities. Public key infrastructures are based on trust relationships between certifying or recommending authorities and the users of these systems. However, these infrastructures are complex to understand, bootstrap, and manage. Therefore, public key infrastructures have not become a mainstream technology for recognizing computer users since they do not provide a simple, easy to use identity recognition system applicable to various types of entities. It is with respect to these considerations and others that the present invention has been made.

### SUMMARY OF THE INVENTION

The above and other problems are solved by a system and method for identity recognition of a group or a group member by a recipient of identity information and for exchange of identity information utilizing identity information signed by the group or by the group member. In effect an identity information document is used to establish and recognize a group membership rather than to establish and recognize a principal's identity. Once a group membership is recognized, members of the group may be recognized based on being authentic members of the group or they may be recognized based on their own personal identity separate from the group. In other words a member may be recognized based on trust by the identity information recipient in the group or based on trust by the recipient in the member personally.

In accordance with other aspects, the present invention relates to a method and system for establishing a group membership in a communication system using a group identity information document. Group identity information is created for inclusion in the group identity information document. A group-signed group identity information document is generated and the document has the group identity information, at least a first key, and a digital signature signed using a second key associated with the first key in the identity information document. The group-signed group identity information document is sent to a receiving system to establish the group identity at the receiving system. A message with the group-signed membership identity information document sent to the receiving system will establish membership of the originator of the membership identity information document in the group whose group identity is established at the receiving system.

According to another aspect of the present invention, the reliability of the identity information in the identity information documents is checked for acceptance of the identity information at the receiving system. A security protocol is assigned to communications from a group member based on the group identity information if a membership certificate for the member is accepted. A security protocol is also assigned to communications from a group member based on the member's personal identity information if a personal identity information document for the member is accepted.

The invention may be implemented as a computer process, a computing system or as an article of manufacture such as a computer program product or computer readable media. The computer readable media may be a computer storage media readable by a computer system and encoding a computer program of instructions for executing a computer process. The computer readable media may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### DESCRIPTION OF THE DRAWINGS

FIG. 1 illustrates at a conceptual level a system for identity recognition according to one embodiment of the present invention.

FIG. 2 illustrates an example of a suitable computing system environment on which embodiments of the invention may be implemented.

FIG. 3 illustrates exemplary software components of a system for identity recognition according to one embodiment of the present invention.

FIG. 4 is a flowchart illustrating initiating an exchange of identity information according to one embodiment of the present invention.

FIG. 5 is a flowchart illustrating receiving identity information according to one embodiment of the present invention.

FIG. 6 illustrates an exemplary format for an identity information document according to one embodiment of the present invention.

FIG. 7 illustrates the operational flow for creating a group identity.

FIG. 8 illustrates the operational flow for creating a membership identity.

FIG. 9 illustrates the operational flow for sending personal identity information documents and membership identity information documents from the initiating system.

FIG. 10 illustrates the operational flow for recognizing personal identity information documents and membership identity information documents at the receiving system and assigning security protocols accordingly.

### DETAILED DESCRIPTION OF THE INVENTION

Before describing various embodiments of the present invention, some terms that will be used throughout this description will be defined.

“Identity information” is a collection of information about a principal in an identity information system through which the principal or its agent is capable of controlling what information is conveyed to a receiving device, and of indicating the intended uses of this information.

An “identity information document” is a subset of identity information for a principal transmitted from one device to another so as to allow the receiving device to represent the originator of the identity information document and subsequently recognize digital events the originator has initiated or responded to.

A “principal” is any entity capable of acting digitally. Principals include individual people, groups or sets of people meaning individuals, households, organizations, explicit groups, and people in common roles, or who share attributes of some kind as well as various electronic devices through which these individuals act.

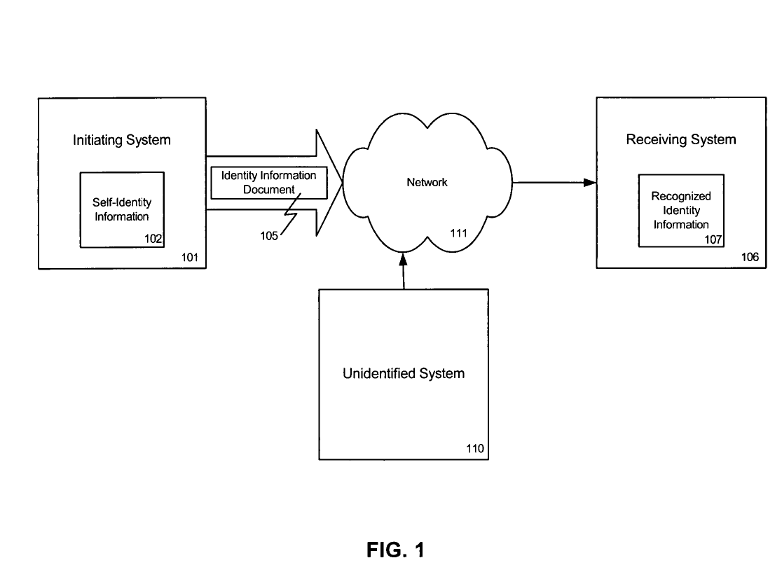

FIG. 1 illustrates at a conceptual level a system for identity recognition according to one embodiment of the present invention. This example illustrates an initiating system 101 and a receiving system 106 connected via a network 111 or other channel. As will become apparent, most devices can function as both an initiating system 101 and a receiving system 106 at various times. However, for simplicity, these functions are illustrated separately here. Additionally, network 111 may be any type of network including the Internet or may be some other type of channel suitable for establishing communication between the initiating system 101 and the receiving system 106.

The initiating system 101 maintains a set of self-identity information 102. The self-identity information 102 may include a variety of information about the principal represented by or using the initiating system 101. This information, for example, may include a name, email address, website URL, and other member information as well as a usage policy describing how this information may be used. These different, identifying elements are referred to herein as identity claims.

An identity information document 105 containing some or all of the self-identity information 102 is created. In one embodiment, the identity information document 105 is created in response to a request from the receiving system 106. Therefore, when a principal represented by or using the initiating system 101 wants to send identity information to another system such as the receiving system 106 the user selects the information to send from self-identity information 102. In other words, the principal has the ability to control disclosure of information from the self-identity information 102 when producing an identity information document 105. Therefore, the principal may selectively disclose different subsets of identity data to different recipients, and express their intent as to how the disclosed information may be used. Further, this allows “progressive disclosure”, where a principal could send a first identity information document containing little information, divulging more information at some later point when there is reason to do so.

In one particular embodiment, the full identity information document is signed with the a digital signature using the private key of the principal originating the identity information document when the identity information document is generated. Therefore, the identity information document is referred to as being self-signed. In another embodiment, the full identity information document has a digital signature signed with the private key of the organization that has issued the identity claims for the principal originating the identity information document when the identity information document is generated. In this case, the identity information document is referred to as being signed by the organization. Similarly, updates to an already shared identity information document or progressive disclosures will be signed using the private key that was used to sign the originally shared identity information. Public keys paired with the signing private key may be distributed in a variety of manners including as part of an identity information document. Alternatively, key arrangements other than the public/private key system may be used. For example, sets of private keys may be used.

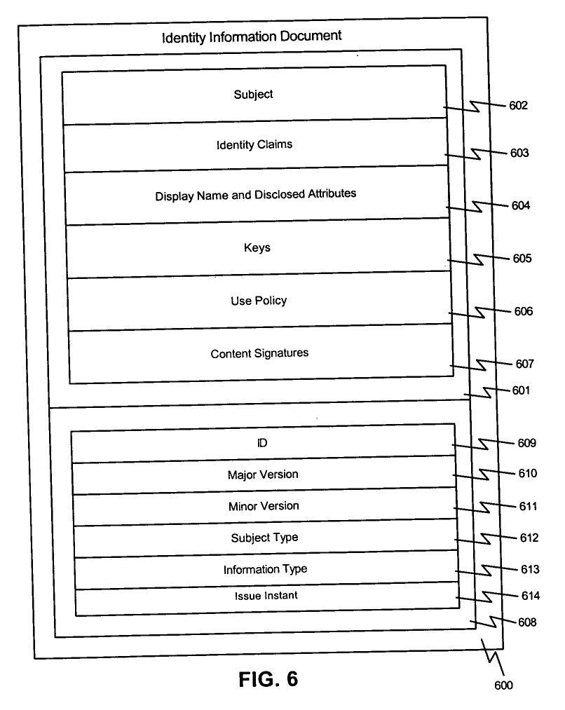

The initiating system 101 produces from the self-identity information 102, the signed identity information document 105 and sends it to the receiving system via network 111. According to one embodiment, the identity information may comprise an eXtensible Mark-up Language (XML) file or a text file that can be sent using any channel to the receiving system 106. Details of one possible format for the identity information document 105 will be discussed below with reference to FIG. 6. However, generally speaking, the identity information 105 may be in a format suitable for transferring information between disparate systems across various types of channels. As mentioned above, the channel used to transfer the identity information document 105 from the initiating system 101 to the receiving system 106 can be any of a variety of possible media. For example, email, instant messaging, beaming, private line and many other mechanisms may be used as channels. Further, the channel may or may not be secure.

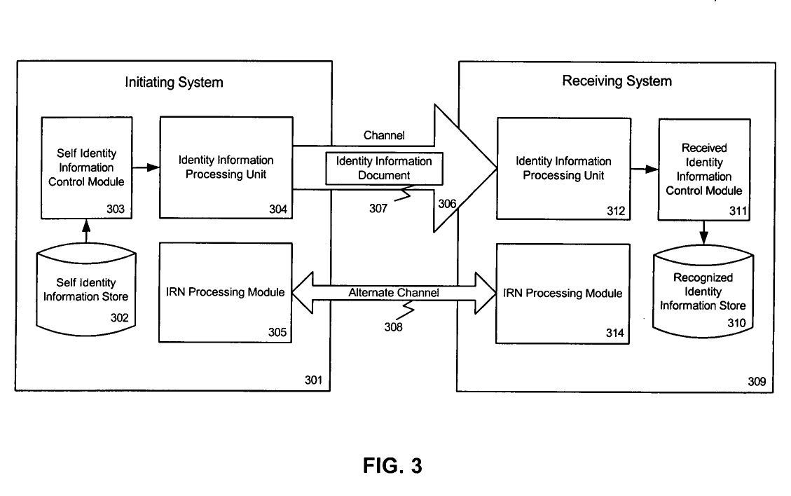

The receiving system 106 reads the incoming identity information document 105 and accepts it or rejects it. In a typical scenario, the identity information document 105 originates from a known principal, and the receiving system 106 will be a very good judge of the authenticity of the identity information document 105. However, if an identity information document 105 arrives from an unknown principal, or if there is a fear that impostors have sufficient motivation to open and modify or forge the identity information document 105, the receiving system 106 may reject the identity information document 105 or seek further verification of its authenticity. Details of this verification will be discussed below with reference to FIGS. 3-6.

Once the identity information document is accepted, the information it contains is added to the recognized identity information 107 of the receiving system 106. Once an identity information document 105 has been added to the list of recognized identity information 107, the receiving system 106 can then use the information it contains to authenticate the initiating system 101 in the future and employ channels of interacting with that principal that may not otherwise be trusted. The principal represented by the identity information document 105 may then, for example, be given access to resources on the receiving system 106 such as a calendar or a document. Alternatively, the principal might be challenged and if the challenge is satisfied, then authorized for access to resources on the receiving system. Conversely, an unidentified principal represented by or using an unidentified system 110 that has not provided an identity information document that has been accepted by the receiving system 106 may be excluded from the resources of the receiving system 106. Likewise, an identified principal represented by or using an identified system 110 that has provided an identity information document that has been accepted by the receiving system 106 may be purposely excluded from the resources of the receiving system 106.

Recognition of a principal through the use of an identity information document 105 and importing identity information into the recognized identity information list 107 does not automatically provide that principal any entitlements on or access to the receiving system 106. It only provides a capability of the receiving system 106 to recognize and authenticate the principal in the future. Recognition or authentication does provide a possibility for authorization of file shares, sending of encrypted mail, automatic updates to previously shared identity information, etc. Anyone may be recognized. Recognition implies only that the receiving system 106 knows who it is dealing with, not that any access rights are given to the principal. Recognizing a principal does not imply giving them access to anything. They can be given access after authorization or when it is useful or safe to do so.

Identity recognition thus works in one direction. Therefore it is necessary to require a two-way exchange of identity information between an initiating system 101 and a receiving system 106 in order for identity recognition to work effectively in either direction. A one-way exchange of an identity information document 105 from the initiating system 101 to the receiving system 106 is sufficient for the receiving system 106 to identify the principal represented by or using the initiating system 101 and deal with that principal as appropriate.

Allowing access to the resources of the receiving system 106 based on the identity information document 105 and recognized identity list 107 does not compromise security if the identity of a principal can be recognized and access can be granted or denied as appropriate or if additional authorization processes can be required. Further, any unrecognized principal can be excluded.

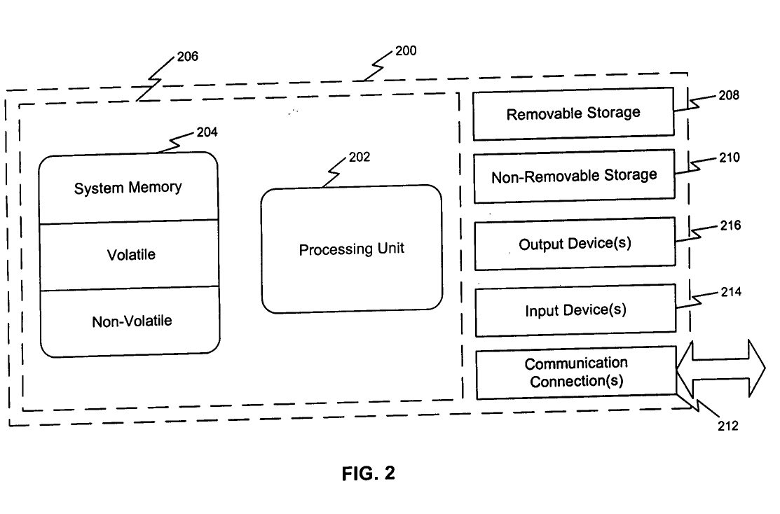

FIG. 2 illustrates an example of a suitable computing system environment on which embodiments of the invention may be implemented. This system 200 is representative of one that may be used to serve as an initiating system and/or a receiving system as described above. In its most basic configuration, system 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. Additionally, system 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210. Computer storage media includes 15 volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital 20 versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 may also contain communications connection(s) 212 that allow the system to 25 communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 200 may also have input device(s) 214 such as keyboard, mouse, pen, voice input device, touch input device, etc. Output device(s) 216 such as a display, speakers, printer, etc. may also be included. All these devices are well know in the art and need not be discussed at length here.

A computing device, such as system 200, typically includes at least some form of computer-readable media. Computer readable media can be any available media that can be accessed by the system 200. By way of example, and not limitation, computer-readable media might comprise computer storage media and communication media.

FIG. 3 illustrates the main software components of a system for identity recognition according to one embodiment of the present invention. This example, similar to that illustrated in FIG. 1, illustrates an initiating system 301 and a receiving system 309 connected via a channel 306. Also, as mentioned above, systems may function as both an initiating system 301 and a receiving system 309 at various times. However, for simplicity, these functions are illustrated separately here.

The initiating system 301 includes a self-identity information store 302, a self-identity information control module 303, an identity information processing unit 304, and an Identity Recognition Number (IRN) processing module 305. The self-identity information store 302 can store information that comprises a database, list, or other collection of information specific to the principal represented by or using the initiating system 301. The self-identity information store 302 can store information such as the principal's name, email address, public keys and/or certificates, and other individualized information that can be used in an identity information document as will be described below.

The self-identity information control module 303 reads identity information from the self-identity information store 302. When a principal wants to send identity information to another system he selects the information to send from the self-identity information store 302 through the self-identity information control module 303. For example, when a principal wants to send an identity information document, a graphical user interface (GUI) may be presented by the self-identity information control module 303 through which the principal selects the information to send from their self-identity information store 302.

The self-identity information control module 303 provides the principal with the ability to control disclosure of information from the self-identity information store 302 when producing an identity information document 307. If presented through a GUI, self-identity information may be presented in a variety of easy to read and easy to use formats. For example, a list of information may be presented for the user to checkmark, or otherwise select, to indicate inclusion in the identity information document. The self-identity information control module 303 therefore allows principals to selectively disclose different subsets of identity information to different receiving systems 309 and express their intent as to how the disclosed information may be used. Further, the self-identity information control module 303 allows “progressive disclosure”, where a principal could send a first identity information containing little information, divulging more information at some later point when there is reason to do so.

The identity information processing unit 304 produces, from the information provided by the self-identity information control module 303, an identity information document 307 and sends it to the receiving system 309 via channel 306. According to one embodiment, the identity information document 307 may comprise an XML file or a text file that can be sent using any channel to the receiving system 309. Details of one possible format for the identity information will be discussed below with reference to FIG. 6. However, generally speaking, the identity information 307 should be in a format suitable for transferring information between disparate systems.

The channel 306 used to transfer the identity information document 307 from the initiating system 301 to the receiving system 309 can be any of a variety of possible media. For example, email, instant messaging, beaming, private line and many other mechanisms may be used as channel 306. The channel 306 may or may not be secure.

The receiving system 309 comprises an identity information processing unit 312, a received identity information control module 311, a recognized identity information store 310, and an IRN processing module 314. The identity information processing unit 312 of the receiving system 309 receives the incoming identity information 307 from the channel 306. The identity information processing unit 312 passes the identity information from the identity information document 307 to the received identity information control module 311.

The received identity information control module 311 determines whether to accept or reject the identity information document 307. In some cases, this determination may be based on querying a user through a GUI as to whether to accept or reject the received information. If presented through a GUI, the identity information from the identity information document may be presented in a variety of easy to read formats. For example, the identity information may be presented in the form of a rolodex or “contacts” entries allowing for quick and easy review of the information.

If the identity information document 307 originated from a known principal, the receiving system 309 will be a very good judge of the authenticity of the identity information document 307. However, if identity information originated from an unknown principal, or if there is a fear that impostors have sufficient motivation to open and modify mail, the receiving system 309 uses the Identity Recognition Number (IRN) processing module 314 to verify the identity information document 307.

Identity information documents 307 can be exchanged over a variety of media. Some media are more susceptible to spoofing than others. When identity information documents 307 are exchanged over more susceptible media like email or when the identification information document 307 is otherwise questionable, it may be beneficial to perform out-of-band verification of the integrity of the identity information document 307 to ensure that it has not been subject to spoofing or man-in-the middle attacks. The degree to which out-of-band verification will be required varies based upon how the identity information is acquired and the sensitivity of the information intended to be shared with the sending party.

To support out-of-band verification of the binding of identification information document 307 to a principal, an Identity Recognition Number (IRN) may be used. The IRN is a hash of the principal's public key with a suitable transformation function to render it as a readable string that is included in the identification information document. The IRN, through this transformation function, may be indicated by an easily readable and memorable series of numbers. For example, the IRN may be similar to a phone number.

To perform out-of-band verification, the IRN processing module 314 of the receiving system 309 computes and displays the IRN for the identity information document 307. The receiving system or user thereof then contacts the originator by an alternate channel 308 such as calling the originator on the phone or through Instant Messaging (IM) and asks the originator to confirm his IRN. The IRN processing module 314 may then verify that the confirmed IRN matches what is computed at the recipient end based on the received identity information document 307.

If a man-in-the-middle attack had tampered with the identity information document 307 received by the receiving system 309 by substituting the public key information to spoof the sender, then the computed IRN would not match the true sender's IRN which would become evident in the out-of-band verification process. Note that the IRN can be public information as it is computed from the public key and, hence, is suitable for inclusion in such things as business cards as an attestation to a person's identity.

Once the identity information document 307 is accepted, the information it contains is added to the recognized identity information store 107. The principal originating the identification information document 307 can then be given access to resources on the receiving system 309. In the future, if the principal tries to access that resource, his or her computer will be challenged to demonstrate knowledge of the private key associated with the public key in the identity information document 307. If the principal is authentic, the computer can provide this proof of knowledge, resulting in recognition and admission to the resource.

Alternatively, even rejected identity information may be placed into the recognized identity information store 107. For example, even though a given set of identity information is rejected, it might be stored for future reference and marked as being unreliable. This recognized but unreliable identity information may be marked as such by being stored in a special portion of the recognized identity information store or by being tagged or flagged in some manner. Such information may be useful in future identification of unreliable identity information.

Additionally, identity information in the recognized identity information store 107 may be made accessible, perhaps through a GUI, for review by a user of the receiving system. If presented through a GUI, the identity information from the recognized identity information store 107 may be presented in a variety of easy to read formats. For example, the identity information may be presented in the form of a rolodex or “contacts” entries allowing for quick and easy review of the information.

Using the system illustrated in FIG. 3, exchanging identity information documents that contain confidential information about its subject can be securely accomplished by utilizing a process of progressive disclosure of identity information. In this process, the originator and the recipient first exchange public keys which may be encapsulated in certificates such as X509v3 certificates, for example, and the minimal necessary identity claims through identity information documents. The parties then exchange the full set of remaining disclosed attributes encrypted with the public key of the recipient of the information. This ensures that the confidential data can only be seen by the intended recipient and nobody else. Of course, it is not mandatory that an exchange of identity information documents be required in order to use the progressive disclosure method. Progressive disclosure can be used for a one-way sharing as well. The progressive disclosure exchanges can occur asynchronously in a stateless fashion, and are not required to be wrapped by a session nor bound to a specific protocol.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

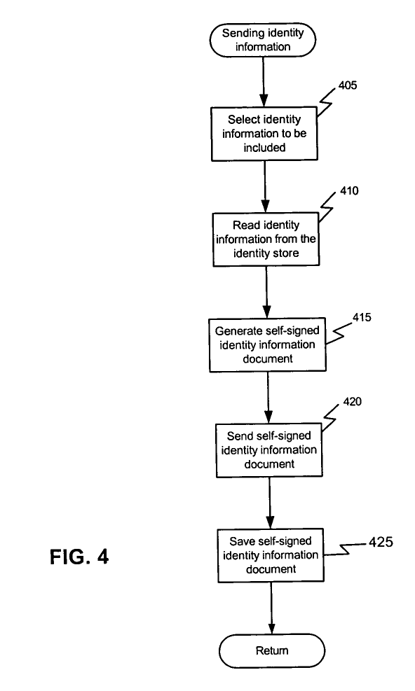

FIG. 4 is a flowchart illustrating initiating an exchange of identity information according to one embodiment of the present invention. Here processing begins with select operation 405. Select operation 405 comprises selecting identity information from the self-identity information store to be included in the identity information document. Select operation selects identity information for inclusion in the identity information document based on user or originator input through a GUI or automatically where pre-selected sets of identity information have been identified for certain situations. Control then passes to read operation 410.

Read operation 410 comprises reading the selected identity information from the self-identity information store. The read operation locates the selected identity information and retrieves the information from the self-identity information store. Control then passes to generate operation 415.

Generate operation 415 comprises generating the identity information document including the information selected and read from the self-identity information store. The generate operation 415 builds the identity information document from the selected information. As will be described below, the identity information document may comprise an XML file. Alternatively, the identity information document may be in any form suitable for transferring information to disparate systems across various media. Additionally, the identity information document includes at least a first key such as one or more public keys, possibly encapsulated in certificates. The identity information document is self-signed with a digital signature using a second key of the originator such as private key paired with one of the public keys included in the identity information document. Control then passes to send operation 420.

Send operation 420 comprises sending the identity information document to the receiving system via a channel. The send operation transmits, communicates or sends the identity information document in an outgoing signal to the receiving system. As discussed above, the channel may or may not be secure. Examples of channels over which the identity information document may be sent include, but are not limited to, email, instant messaging, beaming, private line etc.

Save operation 425 saves the self-signed identity information document for future use by the originator. The document may be saved in the self-identity store at the initiating system. It is not necessary to save the document as it be generated again when needed. However, the advantage to saving the document is that the document does not have to be regenerated in the future. Also, reusing a saved self-signed identity information document in a second communication with a receiving system that has already accepted the document in an earlier communication will save going through a second recognition process at the receiving system.

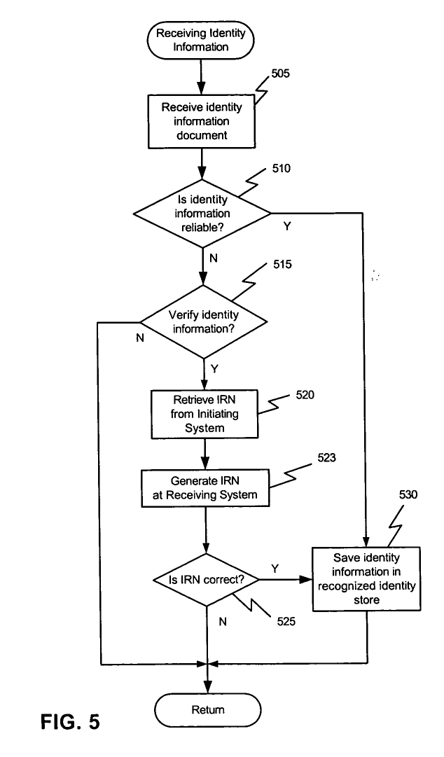

FIG. 5 is a flowchart illustrating receiving identity information according to one embodiment of the present invention. In this example processing begins with receive operation 505. Receive operation 505 comprises receiving an identity information document from a channel such as described above. The receive operation processes the incoming signal from the initiating system to recover the identity information document from the incoming signal. Control then passes to query operation 510.

Query operation 510 comprises determining whether the identity information received in the identity information document is reliable. The query operation tests the authenticity of the identity information based on a number of circumstances related to how the information was received. In some cases the determination of authenticity may simply rely on querying a user through a GUI as to whether to accept or reject the information. In other cases an algorithm of heuristics may be used to make the determination automatically based on the media used to transfer the information, the sensitivity of the information, and any number of other criteria. If the information is determined to be reliable, control passes to save operation 530 where the identity information received in the identity information document is saved in the recognized identity information store. After the save operation writes the identity information into the recognized identity information store, operation flow returns to the main program flow.

If, at query operation 510, the identity information is not determined to be reliable, control passes to query operation 515. Verify query operation 515 comprises determining whether to attempt to verify the identity information document. Verify query operation is deciding whether or not to perform a verification process. This determination may be made automatically by default, may be based on user input through a GUI, or may be based on a number of other criteria programmable by the user. If, at query operation 515 a determination is made to not verify the identity information, no further processing is performed and the operation flow returns to the main program flow. If, however, a determination is made to attempt to verify the identity information, control passes to retrieve operation 520.

IRN Retrieve operation 520 comprises retrieving the IRN from the initiating system or originator. The retrieve operation commands the receiving system or prompts the user of the receiving system to contact the initiating system or originator by an alternate channel. For Is example the user might call the originator on the phone or send a message through IM (instant messaging) and ask the originator to confirm his IRN.

IRN generate operation 523 recreates the IRN at the receiving station based on the public key received in the identity information document. In order to compute the IRN at the IRN generate operation 523 hashes the public key transmitted in the identity information document. Alternatively, the display name (FIG. 6) of the originator may combined with the public key and the combination is then hashed. The result of the hashing operation may then be subjected to a masking algorithm to produce an alphanumeric signature of the form AAA-AA-AA-AA where ‘A’ indicates an alphanumeric characters. The IRN computed by IRN generate operation 523 might look like 732-AB-5H-XVQ. Then the two IRNs are compared by the IRN test operation 525.

IRN test operation 525 comprises determining whether the IRN is correct. IRN test operation 525 compares the computed IRN, generated at the receiving station, to the retrieved IRN retrieved from the initiating system. If a man-in-the-middle attack has tampered with the identity information received by the recipient by substituting the public key information to spoof the sender, then the computed IRN would not match the retrieved IRN from the originator or initiating system, i.e. the true sender.

If the IRN is determined to be correct, control passes to save operation 530. Save operation 530 saves or stores the identity information received in the identity information document in the recognized identity information store. The operation flow then returns to the main control program in the receiving system.

Alternatively, even rejected identity information may be placed into the recognized identity information store. For example, even though a given set of identity information is rejected, it might be stored for future reference and marked as being unreliable. This recognized but unreliable identity information may be marked as such by being stored in a special portion of the recognized identity information store or by being tagged or flagged in some manner. Such information may be useful in future identification of unreliable identity information.

FIG. 6 illustrates an exemplary format for identity information document according to one embodiment of the present invention. As a data structure, the identity information document 600 is a collection of identity claims and other attribute/property claims bound to a key and governed by an embedded use policy. XML will be used as the encoding language for the identity information. However, other formats are considered equally suitable. The elements of the identity information document 600 may also be optionally encrypted if it contains confidential information whose confidentiality must be maintained.

The data within the identity information document 600 can be divided into two categories. These categories include a set of logical components 601 and a set of attributes tags 608. The identity information document has six principal logical components: 1) an identity information subject identifier 602; 2) one or more identity claims of the subject 603; 3) a display name and zero or more selectively disclosed attributes of the subject 604; 4) one or more keys for the subject enveloped in any acceptable formats (for example, public keys in X509v3 certificates) 605; 5) a use policy that expresses the subject's privacy requirements 606; and 6) a digital signature over the entire content of the identity information that protects the integrity of the data and authenticates the sender in the case of identity information updates 607. Each of these six logical components 601 will be discussed in turn.

The subject identifier 602 represents the subject of the identity information as an entity that is identified by one of its identity claims expressed as a name identifier. The preferred name identifier or identity claim for the identity information subject is the email address if the subject type is a person.

Identity claims 603 include structured information that uniquely identifies the subject of the identity information document. An identity claim is a value assigned by an authority of a given type to identify a single principal during a given period of time. The identity claims in an identity information document identify the principal in various namespaces, and the display name and other disclosed information such as a physical mailing address supply further context for the principal once it has been identified.

The display name 604 can be used on the recipient's system during searches and operations. However, it need not be unique. Display name and other disclosed information (such as a physical mailing address) supply additional context for a principal once it has been identified via the identity information's Subject specification. Disclosed Information consists of descriptive information about the subject. This is expressed as a set of properties. Some properties may be standardized, and there may be an extension mechanism.

The keys 605 contains one or more keys, possibly encapsulated within a certificate format (for example, X509v3 certificates). The keys 605 can be public keys and can be included in the identity information as recognition information for the subject of the identity information. If a certificate is used, it may be self-signed or issued by a certificate authority.

The use policy 606 conveys the originator's instructions to the recipient about the uses to which the contents of the identity information may be put. For example, it may indicate that the contents of the identity information should not be divulged to others. The recognized identity information store will store the use policy along with the rest of the information defining the principal, and if a user attempts, for example, to copy a principal which is not intended to be shared, the system will display a warning to the user indicating the originator's intentions.

The digital signature 607 provides signing data within the identity information document. XML signatures have three ways of relating a signature to a document: enveloping, enveloped, and detached. According to one embodiment of the present invention, the identity information document use XML enveloped signatures when signing the identity information content.

The identity information document 600 can carry six attributes tags 608 including: 1) an identity information ID 609; 2) a major version 610; 3) a minor version 611; 4) a subject type 612; 5) an information type 613; and 6) an issue instant 614. Each of these attribute tags 608 will be discussed below.

The identity information ID 609 is an identifier for this identity information document. It provides an identifier with which the identity information document can be referenced from other parts of the document such as the signature.

The major version 610 is the major version number of this identity information document. The minor version 611 is the minor version number of this identity information document.

The subject type 612 is the type of principal that is the subject of this identity information document. There can be various types of principals such as person, computer, organization etc.

The information type 613 is the type of this identity information. For example, a “New” identity information can be imported into the recognized identity information store to create a new principal, or an “Update” identity information can be used to improve an existing principal with more recent changes.

The issue instant attribute 614 is the time instant, expressed in UTC, when the identity information was issued or generated. This time stamp on an update identity information can be used to determine if the existing representation of the identity information's subject is out-of-date or newer.

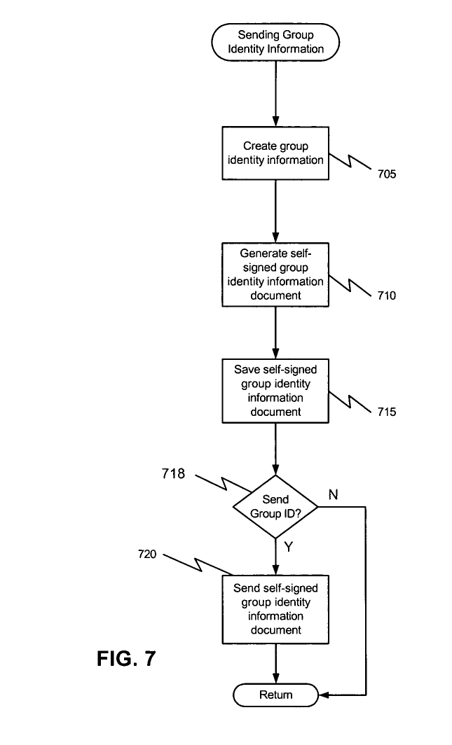

FIG. 7 illustrates the operational flow for automatically creating and saving a group identity information document at the initiating system where the principal is a group, or set, of members. A member of a group is most typically an individual person, but a member may also be another group. A group might be the employees of a corporation, the members of an association, or participants in a project. The group identity information document might for example be created for a corporation when the present invention is first installed in the corporate computing system. Alternatively, a group identity information document can be created by an authorized member of the group, i.e. group owner, at anytime using the operations of FIG. 7 which are similar to the operations of FIG. 4 described above.

In FIG. 7, the operation flow begins with create operation 705 that creates the group identity information. In its simplest form this group identity information would include a group display name such as a corporate name and a first and second key pair associated with the group. As discussed above, the key pair might be a private key and a public key, which is created for the group. From this group identity information generate operation 710 generates a self-signed group identity information document; i.e. group-signed document in this case. This document might be an identity information document for the group and it's simplest form it might be a certificate naming the group and including the public key, or first key, of the group and a digital signature signed using the private key, or second key, of the group. The originator, i.e group owner in this case, would retain the private key, and the group identity information document is group-signed with a digital signature for the group using the private key of the group. Save operation 715 stores this group-signed group identity information document in a storage device at the initiating system such as the identity information store. Alternatively, the group-signed group identity information document need not be stored, but instead the document may be recreated each time it is to be used. However storing the group-signed document for reuse will expedite sending future communications and acceptance of future communications containing the document.

FIG. 7 also shows operations for sending this group identity information document from an initiating system to a receiving system. Send test operation 718 detects whether the group identity information document just generated is to be sent immediately to a receiving station. The originator or group owner may choose to exchange group identity information with a receiving system immediately. If so, the operation flow branches to send operation 720, and the group-signed group identity information document is transmitted to the receiving system. After the send operation the operation flow in FIG. 7 returns to the main program flow in the initiating system. If the group ID is not to be sent now, then the operation flow branches from test operation 718 and returns to the main program flow. The group-signed group identity information document may simply be a certificate including the group public key and a digital signature using the group private key.

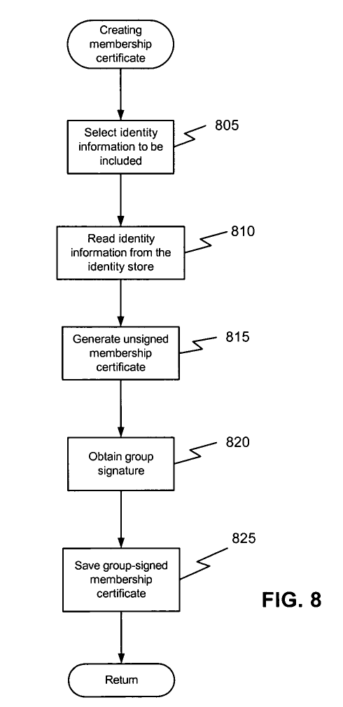

FIG. 8 illustrates the operational flow for an originator creating a membership identity information document or membership certificate. The originator is most often a person in this case; however, the originator could be another group. The operational flow begins at select operation 805 where the person creating the membership certificate selects the identity information to be included in the certificate. This may simply be the person's public key, but it might also include all or a portion of the information fields in the identity information document illustrated in FIG. 6. Read operation 810 reads the selected information from the identity store and passes it to generate operation 815. Generate operation 815 generates an unsigned membership certificate. For the membership certificate to become effective, it must be signed with the group private key by the group owner, i.e. owner of the group private key. Accordingly, the generate operation 815 passes the unsigned membership certificate to the obtain signature operation 820.

Obtain operation 820 sends the unsigned membership certificate to the group owner or may simply send all of the information of the certificate to the group owner. The group owner then signs the membership certificate with group digital signature using the group private key. Typically, this might be accomplished by the group owner receiving the person's public key and generating a group-signed membership certificate using the private key of the group. Once the group-signed membership certificate is generated the operation flow passes to save operation 825. Save operation 825 saves the group-signed membership certificate at the initiating system for current and future use of the person originating the membership certificate.

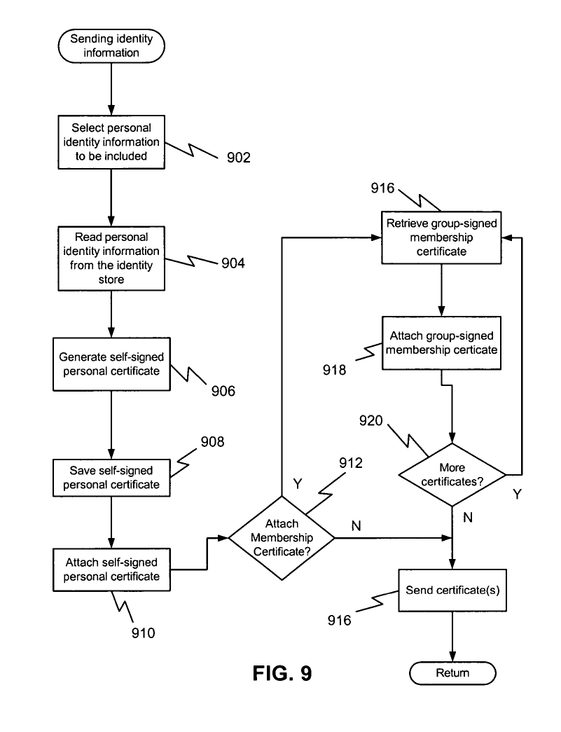

FIG. 9 illustrates the operational flow for sending a self-signed personal certificate with the option of attaching one or more membership certificates. While FIG. 9 illustrates the operation flow for a personal certificate, it should be understood that person as used here includes not only individuals but groups. The operation flow begins at select operation 902. Operation 902 selects the personal identity information to be included in the personal certificate. Read operation 904 receives the selections from select operation 902 and reads the personal identity information from the identity store. Operation 906 then receives this personal identity information and generates the self-signed personal certificate. In its simplest form this personal certificate may have only the public key for the originator of the personal certificate. It, however, could be a more complete self-signed personal identity information document containing all or a portion of the elements in the identity information document of FIG. 6. This personal certificate is self-signed with a digital signature using the private key of the originator.

Once the self-signed personal certificate is generated save operation 908 saves the personal certificate for present and future use by the originator in establishing communications with receiving systems. Of course, the self-signed personal certificate could be recreated or regenerated each time but it is more effective to save the personal certificate for reuse. As described above, this is due to the fact that once a personal certificate has been accepted by a receiving system the originator will want to send the same personal certificate in a subsequent communication so that the acceptance process does not have to be repeated at the receiving system. Attach operation 910 attaches the self-signed personal certificate to the message or e-mail that is to be sent to a receiving system.

Attach membership test operation 912 then detects whether the originator wishes to attach a membership certificate with the personal certificate. If the originator is sending only a self-signed personal certificate, then the operation flow branches “No” from test operation 912 to send certificate operation 914. The personal self-signed certificate is sent, and the operation flow returns to the main program flow in the initiating system.

On the other hand, the originator may wish to attach one or more membership certificates depending upon the receiving system receiving the certificates. In other words, the originator may wish to establish not only his personal identity but his membership identity in groups at the receiving system. If membership certificates are to be attached, then the operation flow branches from attach membership test operation 912 to the retrieve operation 916.

Retrieve operation 916 retrieves the group-signed membership certificate that was stored by save operation 825 in FIG. 8. Typically, the group-signed membership certificate would be in the identity information store at the initiating system. Once the group-signed membership certificate is retrieved, attach operation 918 attaches the group-signed membership certificate to the same e-mail or message that the self-signed personal certificate is attached to. After the membership certificate is attached, more certificates test operation 920 detects whether the originator wishes to attach more membership certificates. If more membership certificates are to be attached, the operation flow returns to retrieve operation 916 to retrieve the next group-signed membership certificate. The operational loop of retrieving membership certificates, attaching membership certificates and testing for more membership certificates continues until all membership certificates that the originator wishes to attach have been attached. The operation flow then branches NO from more certificates test operation 920 to send certificates operation 914. The send operation 914 sends the e-mail or message with all of the personal and membership certificates attached to a targeted receiving system. The operation flow in the initiating system then returns to the main program flow.

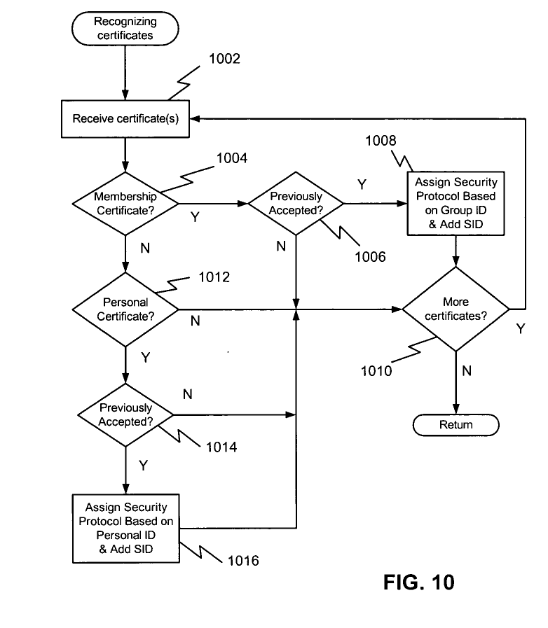

FIG. 10 shows the operational flow for recognizing certificates and assigning security identifications (SIDs) to this communication from the originator of the certificates. The operation flow begins with receive operation 1002 that receives the certificates from the initiating system. Membership test operation 1004 then detects whether the first certificate is a membership certificate. If it is a membership certificate, the operation flow branches to the previously accepted test 1006. Test 1006 detects whether a group certificate, for the group that group-signed this membership certificate, has been previously accepted by this receiving system. If it has not been previously accepted, the operation flow will branch NO and pass to the more certificates test operation 1010. Alternatively, the operation flow could branch NO from the previously accepted test to a reliability and verification process as previously described in FIG. 5. However, this is probably more efficiently handled as a separate communication.

If the group has been accepted, then the operation flow branches YES to assign operation 1008. Assign operation 1008 assigns a security protocol to this communication event from the originator based on the security protocol for the group. Assign operation 1008 then adds or attaches a security ID (SID) designating that the group security protocol be applied to this current communication event with the originator. More certificates test operation 1010 then tests for more certificates being received in this communication from the originator. If there are more certificates, the operation flow returns to receive certificates operation 1002.

If the next certificate received is not a membership certificate, the certificate is then tested to determine if it is a personal certificate by test operation 1012. If the certificate is a self-signed personal certificate, the operation flow branches from test 1012 to previously accepted test 1014. Previously accepted test 1014 detects whether a personal certificate has been previously accepted by this receiving system. If it has not been previously accepted, the operation flow will branch NO and pass to the more certificates test operation 1010. Alternatively, the operation flow could branch NO from the previously accepted test to a reliability and verification process as previously described in FIG. 5. However, this is probably more efficiently handled as a separate communication.

If the personal certificate has been previously accepted, the operation flow branches to assign operation 1016. Assign operation 1016 assigns a security protocol based on the personal ID of the originator. This assign operation adds an additional security ID (SID) to the communication event to reflect this security protocol based on the personal ID. In effect the communication event from the originator now has two SIDs. The operation flow then passes to the more certificates test 1010 and if there are more certificates, the operation flow returns to receive certificates operation 1002. After all certificates have been processed then the operation flow will branch from more certificates test operation 1010 and return to the main program flow in the receiving system. The communication event may then be processed based on all of the SIDs assigned to the communication event from the originator. These SIDs include both his personal SID, if the personal certificate is accepted, and any group membership SIDs whose membership certificates were accepted.

It will be apparent to one skilled in the art that numerous combinations of member identity information documents and group or set identity information documents may be handled by the receiving system. Further, the security protocol may be assigned by the receiving system such that a member transmitting both a member ID and a group ID might have one set of security protocols applied as a member of the group and a second set of security protocols applied as an individual or member. This can be useful, for example, in that an employee of a corporation might be entitled by a security protocol based on group identification to access certain resources in the receiving system while an employee based on his own personal or member identification might be entitled to access a second set of resources in the receiving system.

Although the invention has been described in language specific to computer structural features, methodological acts and by computer readable media, it is to be understood that the invention defined in the appended claims is not necessarily limited to the specific structures, acts or media described. As an example, different formats other than XML may be used to encode identification information. Therefore, the specific structural features, acts and mediums are disclosed as exemplary embodiments implementing the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. In an initiating system, a method for establishing a group membership with a group identity information document comprising:
creating group identity information for inclusion in the group identity information document; and
generating a self-signed group identity information document comprising the group identity information, at least a first key, and a group identity information document signature signed using a second key associated with the first key in the identity information document.

2. The method of claim 1 further comprising:
sending the group-signed group identity information document to a receiving system to establish the group identity at the receiving system.

3. The method of claim 2, further comprising:
sending a group-signed membership identity information document with the group-signed group identity information document to the receiving system to establish membership of an originator of the membership identity information document in the group identity established at the receiving system.

4. The method of claim 3 further comprising:
receiving the group-signed membership identity information document from the originator;
detecting whether the group associated with the membership identity information document has been accepted; and
assigning security protocols to communications from the originator based on the group identity information if the group identity information is accepted.

5. The method of claim 3, wherein the act of sending comprises:
storing the group-signed membership identity information document in an initiating system;
retrieving the group-signed membership identity information document;
attaching the group-signed membership identity information document to the message; and
sending the message to the receiving system.

6. The method of claim 3, further comprising:
sending to the receiving system a self-signed personal identity information document of the originator of the message to establish at the receiving system identity of the originator in addition to originator's membership in the group.

7. The method of claim 6, wherein the acts of sending a self-signed personal identity information document and group-signed membership identity information document comprise;
generating the self-signed personal identity information document;
attaching the self-signed personal identity information document to the message;
retrieving the group-signed membership identity information document;
attaching the group-signed membership identity information document to the message; and
sending the message to the receiving system.

8. The method of claim 6 further comprising:
receiving the group-signed membership identity information document and the self-signed personal identity information document from the originator;
detecting whether the group associated with the membership identity information document is accepted and whether the person associated with the personal identity information document is accepted;
assigning first security protocols to communications from the originator if the group is accepted; and
assigning second security protocols to communications from the originator if the person is accepted.

9. In a communication system, apparatus for establishing a group identity comprising:
a group ID generate module generating a group certificate having at least a public key and a digital signature for the group; and
a send module transmitting the group certificate to establish the group identity at a receiving system.

10. The apparatus of claim 9 further comprising:
an attach module attaching a group membership certificate to a message originated by a sender;
the send module transmitting the message to the receiving system to establish the sender as a member of the group at the receiving system.

11. The apparatus of claim 10 further comprising:
a membership ID generate module generating a membership certificate having at least a public key of the sender and a digital signature for the group;
a save module, responsive to the membership ID generate module, storing the membership certificate;
a retrieve module retrieving the membership certificate from the save module and providing the membership certificate to the attach module.

12. The apparatus of claim 10 further comprising:
a receive module at the receiving system receiving the membership certificate;
an accept module at the receiving system detecting whether to accept the membership certificate.

13. The apparatus of claim 12 further comprising:
an assign module assigning a security identification to communications from the sender based on the group associated with the membership certificate if the membership certificate is accepted by the accept module.

14. The apparatus of claim 10 further comprising:
a personal ID generate module generating a personal certificate having at least a public key of the sender and a digital signature by the sender;
the send module transmitting the personal certificate to establish the sender's identity at the receiving system.

15. The apparatus of claim 14 further comprising:
a receive module at the receiving system receiving the certificates;
an accept module at the receiving system detecting if the certificates are to be accepted;
an assign module assigning a security protocol to communications from the sender based on a group identity associated with the membership certificate if the membership certificate is accepted by the accept module; and
the assign module assigning a security protocol to communications from the sender based on personal identity associated with the personal certificate if the personal certificate is accepted by the accept module.

16. A computer readable medium readable by a computing system and encoding a computer program of instructions for executing a computer process for establishing a group identity in a communications between an initiating system and a receiving system, said computer process comprising:
generating at the initiating system a group certificate having at least a group public key and a digital signature for the group signed with a group private key associated with group public key; and
sending the group certificate to the receiving system to establish the group identity at the receiving system.

17. The computer readable medium of claim 16 wherein the process further comprises:
sending a membership certificate to the receiving system to establish the originator as a member of the group at the receiving system.

18. The computer readable medium of claim 17 wherein the process further comprises:
creating the membership certificate at the initiating system, the membership certificate having at least a public key of the originator and a digital signature signed using the group private key.

19. The computer readable medium of claim 17 wherein the process further comprises receiving the membership certificate at the receiving system; and
testing acceptance of the group identity received in the membership certificate.

20. The computer readable medium of claim 19 wherein the process further comprises assigning a security protocol to communications from the originator based on the group identity if the membership certificate is accepted by the act of testing.

21. The computer readable medium of claim 17 wherein the process further comprises generating a personal certificate having at least a public key of the originator and a digital signature for the originator signed by the originator with a private key associated with the public key of the originator;
sending the personal certificate to establish the personal identity of the originator at the receiving system.

22. The computer readable medium of claim 21 wherein the process further comprises accepting the identity information in the certificates received at the receiving system if the certificates have been previously accepted;
assigning a security identification to communications from the originator based on the group identity information if the membership certificate is accepted; and
assigning a security identification to communications from the originator based on the personal identity information of the originator if the personal certificate is accepted.
